(19) United States
(12) Patent Application Publication
(10) Pub. No.: US 2026/0032272 A1
(43) Pub. Date: Jan. 29, 2026

(54) CONFIGURATION RECORD AND RECORD LISTS/VIDEO CODECS

(71) Applicant: APPLE INC., Cupertino, CA (US)

(72) Inventors: Seethal PALURI, San Diego, CA (US); Dimitri PODBORSKI, Cupertino, CA (US); Alexandros TOURAPIS, Cupertino, CA (US); Jungsun KIM, Cupertino, CA (US)

(21) Appl. No.: 19/245,833

(22) Filed: Jun. 23, 2025

Related U.S. Application Data
(60) Provisional application No. 63/674,980, filed on Jul. 24, 2024.

(51) Int. Cl. H04N 19/30; H04N 19/172; H04N 19/597; H04N 19/70

(52) U.S. Cl. CPC H04N 19/30; H04N 19/172; H04N 19/597; H04N 19/70

(57) ABSTRACT

The present disclosure describes improvement in the design of syntaxes that carry bandwidth-compressed media between encoders and decoders. In particular, it relates to improvements in representation of parameter sets and a prediction process between parameters sets. According to embodiments of the disclosure, a coding system represents data or other information according to a syntax that is categorized and organized into types and hierarchies, where information of the lower layers or levels of the hierarchy are predicted from information of the higher levels. Although the present discussion discusses primarily video applications, the principles of the present disclosure find application with other types of data that may be partitioned into units, groups of units, or layers, and for which parameter set information may be present at different stages/levels of the information unit hierarchy. For example, such data could include audio data, mesh or point-cloud information, text, among others.

### CLAIM FOR PRIORITY

This application claims the benefit of U.S. Provisional Application No. 63/674,980, filed on Jul. 24, 2024 and entitled “Configuration Record and Record Lists/Video Codecs,” the disclosure of which is incorporated by reference herein.

### BACKGROUND

The present disclosure relates to media coding systems.

Media coding finds application in a variety of computing environments. Typically, a media encoder generates a bandwidth-compressed representation of a source media element and transmits the bandwidth-compressed representation to a media decoder in a bitstream, which inverts the coding operations performed by the media encoder and obtains a recovered representation of the source media. The media encoder and media decoder typically operate according to a coding protocol that defines the coding/decoding operations that may be performed upon the media and a syntax that is to be employed to identify the coding operations that the media encoder applied to the source media, and to represent the coded media obtained from those coding operations.

It can be advantageous to have included within the coded bitstream descriptive information of the type of data contained in it early on within the bitstream. This information is commonly referred to as the High Level Syntax (HLS) of the bitstream and such information may be present at different locations within the bitstream hierarchy. This information allows a system to interpret the media contents before decoding or processing it. For example, these descriptions can be used to indicate the extent of capabilities that can be handled by the bitstream (or sub-units within it) or be used to provide information to the device or service on how to handle the media. Furthermore, it may also provide an indication on the coding tools supported within the bitstream or its subunits. This type of information may exist at multiple levels within the media coding hierarchy, e.g. at a sequence layer, group of frames or pictures, sub-picture level and so on, with each coding hierarchy level including information that is vital for that level and beyond. For instance, information that is present in the sequence level can impact all frames associated with that sequence, while information associated with a frame/picture level will only apply to information associated with the corresponding/associated frame or picture.

Parameter sets or header information is often used in coding systems to categorize and organize information into hierarchies, wherein each level of the hierarchy would contain information that could be shared across multiple video coding units. This allows information present in various levels of the coding hierarchy to persist for differing lengths of time, thereby minimizing or removing the need for repetitive signaling of the information. Otherwise, such signaling can add to the overhead and impact coding efficiency. In particular, such overhead can prove costly if it has to be frequently signaled, especially in a band-limited environment, and could lead to a quality degradation since otherwise that bandwidth could be used for indicating other types of information crucial for reconstruction.

A few examples of parameter sets that are commonly defined in existing specifications include the video parameter set, the sequence parameter set, picture or frame parameter set, and so on. A video parameter set, may contain information that is specific to the number of layers (which may be spatial, temporal, auxiliary etc.), indications of profile, level, and tier parameters for each layer, timing, decoder model and information on operating points that are of particular interest in multilayer applications (e.g. scalable or multiview applications). A sequence level parameter set may also contain information of the profile, level, or tier for a specific layer that the sequence level parameter is associated with, as well as also information related to the tools present in the bitstream/layer and the decoded picture buffer capacity. A picture parameter set would typically contain information related to a particular picture/frame, such as about the types of partitioning that are present, transform types used, relationship between the current picture/frame and its references, quantization information such as a global QP parameter or quantization matrices, certain high level motion information such as the number of bits to be used for the motion information or particular motion models that can be supported, loop filter information and so on. Sub-picture level parameter sets can also be used. Information present in the bitstream can be partitioned and distributed into different levels of information hierarchy. Here, the minimally varying data that has the longest persistence is signaled the least frequently. Whereas data that is frequently varying can be signaled more often.

Many ITU-T/MPEG video coding specifications such as Rec. ITU-T H.264/AVC, Rec. ITU-T H.265/HEVC, and Rec. ITU-T H.266/VVC use parameter sets while current AOM video coding specifications such as AV1 use headers to convey similar high level syntax information. In the case of these ITU-T/MPEG coding specifications, and to ensure error resiliency and decodability of the bitstreams, parameter sets can be signaled in-band or out-of-band. In-band parameter sets are indicated directly in the bitstream, while out-of-band parameter sets may be present in the bitstreams, available through external means, or inferred by an application or service. Services, for example, could constrain the values of the parameter sets used based on their requirements and to improve their quality of service. By indicating parameter sets out of band, this could help such services to reduce bandwidth and guarantee the error resiliency of such information (since they do not need to be transmitted) given their essentiality to the decoding process.

Parameter sets are essential for multiple reasons. They can provide information that relate to the decoding process, e.g. they can specify parameters such as format of a decoded video image, indicate which coding tools are enabled, or other configuration parameters. They can also indicate overall complexity information to a decoder to understand if it can handle the decoding of the bitstream or information that helps the decoder properly configure itself for handling the data. Other purposes include providing information to the system level to ease/enable processing and bitstream analysis and manipulation (e.g. for handling trick modes/random access). Given the essentiality/importance of such information, commonly existing video coding specifications that utilize parameter sets are designed without any parsing dependency between such parameter sets. This allows each parameter set to be transmitted and parsed independently from one another. One advantage that parameter sets have over headers is that such parameter sets can be shared across multiple coding units, e.g. frames or tiles. However, when such units need to utilize some different information, e.g. different quantization matrices or loop filter parameters, the entire parameter set needs to be send with any updated parameters. Unfortunately, the existing designs do not exploit any possible redundancies in the information that a parameter set conveys. Even if there is a single parameter change, the entire parameter set/header information needs to be signaled again. It is stipulated that the size of the parameter sets can vary from a few bytes to several kilobytes (as in the case of AV1 and VVC), which could result in considerable overhead.

### BRIEF DESCRIPTION OF THE DRAWINGS

FIG. 1 illustrates a media coding and decoding system suitable for use with embodiments of the present disclosure.

FIG. 2 illustrates exemplary use of configuration records according to an embodiment of the present disclosure.

FIG. 3 illustrates an exemplary buffer management technique according to an embodiment of the present disclosure.

FIG. 4 illustrates an exemplary architecture of a dependent configuration record according to an embodiment of the present disclosure.

FIG. 5 illustrates an exemplary application of predictively coded configuration records to a multi-layer hierarchy.

FIG. 6 illustrates an exemplary buffer management technique according to another embodiment of the present disclosure.

FIG. 7 is a functional block diagram of a coding system according to an aspect of the present disclosure.

FIG. 8 is a functional block diagram of a decoding system according to an aspect of the present disclosure.

### DETAILED DESCRIPTION

The present disclosure describes improvements in the design of syntaxes that carry bandwidth-compressed media between encoders and decoders. In particular, it relates to improvements in the representation of parameter sets, referred to here also as configuration records, and the prediction process between parameters sets or configuration records of the same type. For example a system may contain a set of video parameter sets (also referred to here as layer or layer type configuration records) that describe parameters that relate to layered coding of a video sequence such as the characteristics and relationships between temporal and/or spatial layers and their functionalities or capabilities, sequence parameter sets (also referred to here as sequence or sequence type configuration records) that describe coding parameters and information that relate to an entire coded layer sequence, picture parameter sets (also referred to here as picture or picture type configuration records) that relate to coding parameters and information that may relate to a single coded picture and so on. When decoding a video sequence and sub-components within it such information are all referred to determine how the decoding process but also other operations including processing and display (e.g. color interpretation and visualization) could or should be performed. Although the present discussion discusses primarily video applications, the principles of the present disclosure find application with other types of data that may be partitioned into units, groups of units, or layers, and for which parameter set information may be present at different stages/levels of the information unit hierarchy. For example, such data could include audio data, mesh or point-cloud information, text, among others.

According to embodiments of the disclosure, a coding system represents data or other information according to a syntax that is categorized and organized into hierarchies, where the lower layers or levels of the hierarchy are encapsulated by the higher levels. For example, one category may be used to indicate information that is frequently varying, while another category may be used to indicate static information. There may be several other categories that can be used to tag information between these two levels, e.g. information that relates to loop filters, intra vs inter prediction, timing information, display output related information, among others. It should be noted that in such a coding system, coding records can be read independently, including coding records at lower levels, which can be read independently of coding records at higher levels. However, such records could also potentially use information available in the higher layers for reconstruction but not vice versa as the higher levels are commonly decoded first and therefore should not depend on the lower levels of the hierarchy. Independency may also be required to support applications that may expect support of different operating points, e.g. in a multiview scenario having the ability to decode only 1 view, in a scalable scenario being able to stream or decode a lower quality representation of the sequence etc. Such order-based categorization of the data in a coding system allows the data in each level to be prioritized differently at the network layer. Typically, the higher levels in the coding hierarchy may be used as indication of importance of information carried within a coded entity, and therefore could be used in conjunction with powerful and often unequal error correcting codes.

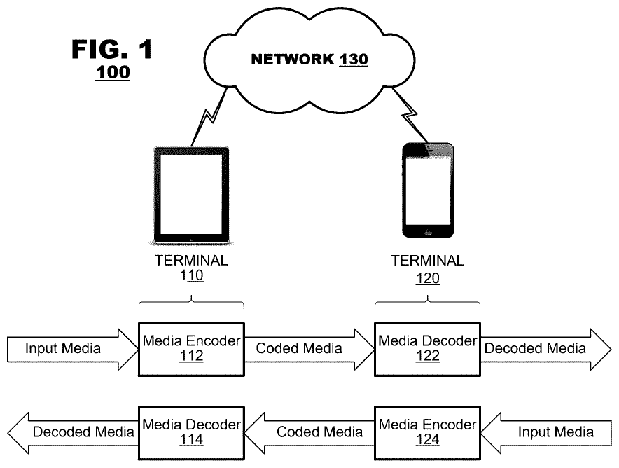

The principles of the present disclosure find application in a media coding and decoding system 100 such as shown in FIG. 1. As illustrated in FIG. 1, a pair of terminal devices 110, 120 may be provided in mutual communication over a network 130. The terminals 110, 120 may exchange coded media either unidirectionally or bidirectionally over the network 130. For a unidirectional media exchange, for example, a first terminal 110 may possess a media encoder 112 that codes input media into a coded representation that is bandwidth-compressed in comparison to the input media. The first terminal 110 may transfer the coded media to the second terminal 120 over the network 130. The second terminal 120 may possess a media decoder 122 that inverts coding operations applied by the media encoder 112 and generates a decoded media stream therefrom. Coding operations may be lossy processes and, therefore, the decoded media may represent the input media from which it is derived but with some loss in information content.

Many unidirectional coding applications involve one to many transfer operations in which a first terminal 110 codes the media once and makes it available for transfer to many other devices (one of which is shown as the second terminal 120). One common technique involves storing coded media at the first terminal 110, for example, a storage system. The multiple consumption device(s) 120 may download portion(s) of the coded media asynchronously from each other.

For bidirectional media exchange, the coding/decoding process may be repeated for media exchange in the opposite direction, from terminal 120 to terminal 110. In such an implementation, the terminal 120 may possess its own media encoder 124. The media encoder may code a second input media into a coded representation that is bandwidth compressed in comparison to the input media. The second terminal 120 may transfer the second coded media to the first terminal 110 over the network 130. The first terminal 110 may possess a media decoder 114 that inverts coding operations applied by the second media encoder 124 and generates a second decoded media stream therefrom. Again, the coding operations of the second media encoder 124 and the second media decoder 114 may be lossy processes that cause loss of information if the second decoded media were compared to the second input media.

Typically, in bidirectional media exchanges, the source media at the first and second terminals 110, 120 are independent from each other. The processing operations performed by the first media encoder 114 and the first media decoder 122 may be performed independently of the processing operations performed by the second media encoder 124 and the second media decoder 114.

The terminals 110, 120 may operate according to a coding protocol that defines candidate coding processes that may be performed on input media (usually, by specifying the decoding processes that are to be performed to invert them) and a syntax by which selections of coding processes and the coded media generated therefrom are represented.

Embodiments of the present disclosure employ configuration records that may be developed predictively from other configuration records. Configuration records may contain sets of coding parameters that are used by encoders and decoders to code media. A variety of coding protocols already define metadata elements that convey parameter information from an encoder to a decoder. As discussed, the ITU-T/MPEG video coding specifications such as Rec. ITU-T H.264/AVC, Rec. ITU-T H.265/HEVC, and Rec. ITU-T H.266/VVC convey coding parameters in parameter sets (e.g. sequence parameter sets, picture parameter sets, and the like) while current AOM video coding specifications such as AV1 use headers to convey the information. Under the present proposal, such parameter information may be conveyed in configuration records and select configuration records may be developed predictively from other configuration records.

In such embodiments, a media encoder 112 may supply configuration records to a media decoder 122 as part of the coded media bitstream. Certain configuration records may indicate that one or more parameter elements of the configuration record is to be derived from one or more configuration records previously supplied by the media encoder 112. The configuration record(s) thus developed provide parameter information that is to be employed by the media decoder 122 when decoding other elements of the coded media. For example, a configuration record may relate to a sequence of video frames and provide parameter data that is relevant to the video frames within that sequence. Another configuration record may relate to one of the video frames and provide parameter data that is relevant to the one video frame. Thus, a media decoder 122 may maintain information of such configuration records persistently for use during decoding operations until such time that it is appropriate to discard them.

According to an embodiment of the present disclosure, each configuration record may be provided as one of two types: An independent configuration record or a dependent record. An independent configuration record, as its name implies, is a configuration record that is self-contained and does not refer to any other configuration record as a source of information content. A dependent configuration record, however, relies on another configuration record as a source of information content.

According to another embodiment of the present disclosure, each configuration record may be assigned a unique identifier that distinguishes the configuration record from other configuration record(s) that may be maintained by the encoder and decoder. It may occur that, in a coding protocol that is designed to accommodate configuration records according to the proposed embodiments, the coding protocol will support a fixed number of active configuration record identifiers (for example, 32 or 64 configuration records of a particular type) at any given time. In such applications, when it becomes appropriate to send another configuration record identifier of a particular type in excess of the coding protocol's limit, an already assigned configuration record identifier of a particular type may be assigned to the new configuration records of that type. Reuse of a configuration record identifier may have the effect of disqualifying from further use an earlier-provided configuration record with that configuration record identifier in favor of the new configuration record with the same identifier.

A dependent configuration record may have identifier(s) that identify source(s) of prediction for content of the dependent configuration record.

FIG. 2 illustrates exemplary use of configuration records according to an embodiment of the present disclosure. This example shows six configuration records 210-260 each having a configuration record identifier that is unique among the configuration records 210-260. In this example, configuration records 210 and 240 are illustrated as independent configuration records, and configuration records 220, 230, 250, and 260 are illustrated as dependent configuration records. Configuration records 220 and 230 each depend from configuration record 210 and possess another identifier (ref_id) that identifies configuration record 210 as their source of prediction. Similarly, configuration records 250 and 260 each depend from configuration record 240; they possess ref_id identifiers that identify configuration record 240 as a source of prediction for those configuration records 250, 260.

The use of prediction among configuration records involves memory management techniques to ensure that record information is available to support prediction among the configuration records. As configuration records are developed between an encoder and a decoder (FIG. 1), the configuration records will be accessed to support coding and decoding operations between them. Thus, encoders and decoders may develop buffers to store the data of the configuration records. For dependent configuration records, the buffers may store parameter data developed via prediction from the other configuration records on which they rely. Thus, to support coding and decoding operations, the configuration records are maintained by the encoders and decoders for as long as they are used to support those coding and decoding operations.

Moreover, as the configuration records are developed between the encoder and decoder, the configuration records that serve as sources of prediction for later-developed configuration records are used to support those prediction operations. Thus, the configuration records that are to be used as sources of prediction are maintained by the encoders and decoders for as long as they are used to support those prediction operations.

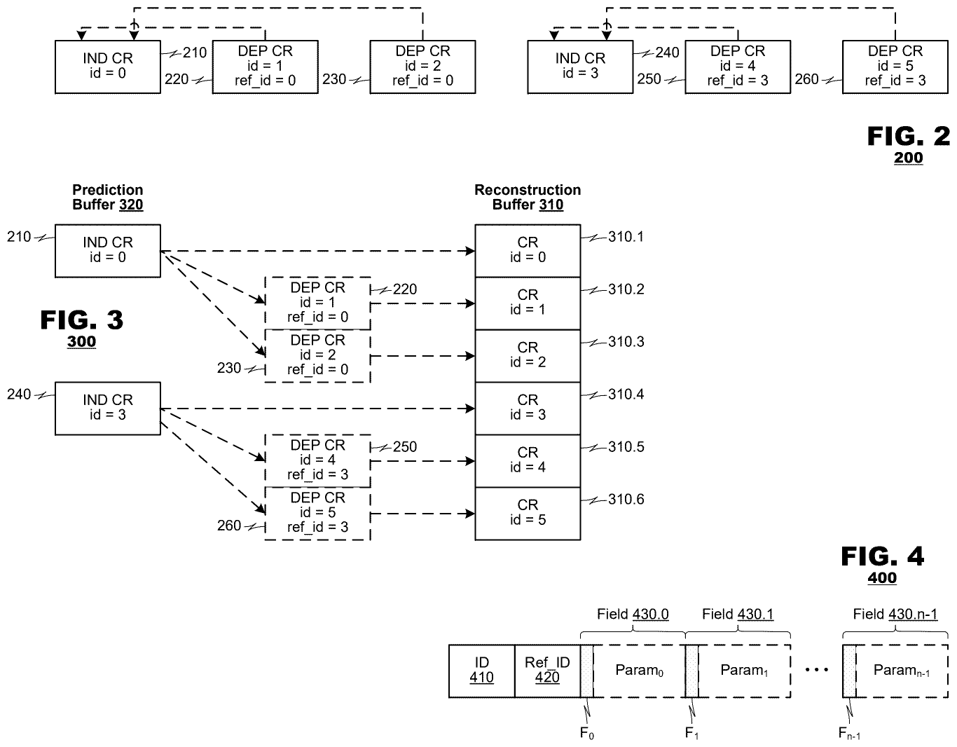

FIG. 3 illustrates an exemplary buffer management technique according to an embodiment of the present disclosure. The example of FIG. 3 illustrates buffer management in the context of the configuration records 210-260 illustrated in FIG. 2. In this embodiment, an encoder or a decoder may maintain a pair of buffers, a reconstruction buffer 310 and a prediction buffer 320. The reconstruction buffer 310 may store recovered configuration records for use in coding/decoding operations performed by the encoders and decoders, respectively. Thus, in the example of FIG. 2, where six configuration records 210-260 are conveyed between the encoder and decoder, FIG. 3 illustrates six recovered configuration records 310.1-310.6 in the coding/decoding buffer 310.

The example of FIG. 3 also shows a prediction buffer 320 for a single record type. The prediction buffer 320 may store configuration records that are used as sources of prediction for later-developed configuration records. In the example of FIG. 2, where independent configuration records 210, 240 are the only configuration records that are used as sources of prediction for other configuration records 220, 230, 250, 260, the prediction buffer 320 is illustrated as storing configuration records 320.1, 320.2 corresponding to configuration records 210, 240 in FIG. 3.

The configuration records as stored in the reconstruction buffer 310 may be recovered according to their configuration record type. That is, independent configuration records 310.1, 310.4 may be stored in the reconstruction buffer 310 after having been reconstructed according to the information communicated between the encoder and decoder (FIG. 1) in the transmitted configuration records 210, 240 and according to any default parameter sets on which the independent configuration records may rely (for example, those set according to a video layer to which the independent configuration record belongs). Dependent configuration records 310.2, 310.3, 310.5, 310.6 may be stored in the reconstruction buffer 310 after having been reconstructed according to the information communicated between the encoder and decoder (FIG. 1) in the respective transmitted configuration records 220, 230, 250, 260 and the other configuration records (e.g., configuration records 210 or 240) to which they refer. The data flow for reconstruction of the configuration records stored in the reconstruction buffer 310 is shown in FIG. 3 in phantom.

Note further that the principles of the present disclosure do not require that the coding/decoding buffer 310 and the prediction buffer 320 be stored in discrete memory locations within a computing device. The coding/decoding buffer 310 and the prediction buffer 320 may be virtual buffers rather than physical buffers in storage. If convenient, a computing device may store a single copy of a configuration record (say, record 210) in memory, and employ memory management techniques to assign that copy to a virtual coding/decoding buffer 310 and a virtual prediction buffer 320. The computing device would allow the copy of the configuration record 210 to be evicted from storage only when it is appropriate to evict the configuration record from both the coding/decoding buffer 310 and the prediction buffer 320.

The configuration records 210-260 shown in the examples of FIGS. 2 and 3 relate to configuration records of a single type (e.g. a layer, sequence, or picture configuration record). In many coding systems, configuration records will be used to communicate parameter between encoders and decoders (FIG. 1) for several different types, each of which communicates parameter information at different such granularities within the coding syntax. Thus, the principles of FIGS. 2 and 3 may be repeated at each of these type granularities.

FIG. 4 illustrates an exemplary architecture of a dependent configuration record 200 according to an embodiment of the present disclosure. Here, the configuration record 200 is shown as containing an identifier field 410, a reference identifier (ref_id) field 420 and a plurality of data items. The ID field 410 distinguishes the dependent configuration record from other configuration records maintained by the system. The reference identifier 420 may identify another configuration record from which the dependent configuration record 200 depends. The configuration record 200 also may contain one or more data fields 430.0-430.n-1 that relate to data fields to which the configuration record corresponds. The data fields 430.0-430.n-1 each may contain a flag F₀, F₁, . . . , Fₙ₋₁ that indicate whether parameter data Param₀, Param₁, . . . , Paramₙ₋₁ is present in the respective data field 430.0-430.n-1. Again, if data for a given parameter (say, Param₁) is to be derived from a prediction source, the flag F₁ of the data field 430.1 may be set to a predetermined value and parameter data for the field 430.1 need not be provided by an encoder when data of the configuration record 200 is communicated to the decoder.

Use of dependent configuration records is expected to achieve bandwidth savings in coding systems 200 that employ highly-related parameter sets. In coding applications where an encoder revises a relatively small number of parameters in a given parameter set, the encoder need only provide data of the revised parameters in a dependent configuration record. For parameters that are unchanged as compared to a prior configuration record, the encoder simply may identify the prior configuration record in the ref_id field 420 and may set flags for fields that are unchanged to indicate that a decoder is to obtain parameter data for those field(s) from the configuration record identified by the ref_ID field 420.

The frequency of updating configuration records may be based on the characteristics and need of persistence of the information being signaled. As a case in point, profile information persists for the entire bitstream, whereas quantization, transform parameters typically change more frequently. Therefore, a configuration record type that provides sequence profile information typically will be signaled to a decoder fewer times and with fewer updates than configuration record types that provide quantization- and transform-related parameters.

For instance, it may be possible to have a single flag to control the presence of intra parameters in the PCR or another flag to indicate the presence of inter parameters and so on. These sub-component flags or indices can be used to update the syntax elements or retain the existing values. To elaborate further, these flags can be used to indicate if the existing parameter values need to be retained, or if new values would be signaled or if new values would be predicted. If the values are to be predicted, an indication of which configuration record it will be predicted from also needs to be indicated. The frequency of updating parameters or parameter sets is based on the characteristics and need of persistence of the information being signaled. As a case in point, profile information persists for the entire bitstream, whereas quantization, transform parameters typically change more frequently. Therefore, the sequence profile information needs to be signaled fewer times and with fewer updates than quantization and transform related parameters.

Table 1 illustrates an exemplary syntax for a sequence level independent configuration record. In this embodiment, the independent configuration record's identifier is shown as scri_indep_id. In this example, a decoding buffer of independent sequence configuration records (indSCRbuffer) with 32 elements is allocated. Dependent configuration records may refer to the independent configuration record by the scri_indep_id identifier and independent sequence configuration records are stored in the i-th entry, with i=scri_indep_id of indSCRbuffer. A second buffer named SCRbuffer is also allocated with also 32 elements. This buffer is utilized to store the sequence configuration records that will be utilized from the coded video data. In this case the syntax element scri_id provides an identifier of where this independent record will be stored, upon its parsing, in SCRbuffer.

TABLE 1
Exemplary Syntax of a sequence type
Independent Configuration Record

| | Type |
|---|---|
| seq_config_record_indep( ) { | |
| /* General */ | |
| scri_indep_id | f(5) |
| scri_id | f(5) |
| scri_lcr_id | f(5) |
| ... | |
| /* Control flags for default use cases */ | |
| scri_use_default_common_enable_flags | f(1) |
| scri_use_default_partition_enable_flags | f(1) |
| scri_use_default_intra_tool_enable_flags | f(1) |
| scri_use_default_inter_tool_enable_flags | f(1) |
| scri_use_default_tx_quant_enable_flags | f(1) |
| /* Tools used by both inter and intra frames */ | |
| if (scri_use_default_common_enable_flags) { | |
| ... | |
| } | |
| /* Tools related to partitioning */ | |
| if ( !scri_use_default_partition_enable_flags ) { | |
| ... | |
| } | |
| ... | |
| } | |

In a separate example, as shown in Table 2, scr_id and scr_indep_id are combined and only scr_id is sent. In this case proper handling of independent configuration records vs all records need to be performed as described in subsequent sections.

TABLE 2
Exemplary Syntax of a Sequence Type
Independent Configuration Record

| | Type |
|---|---|
| seq_config_record_indep( ) { | |
| /* General */ | |
| scri_id | f(5) |
| scri_lcr_id | f(5) |
| ... | |
| /* Control flags for default use cases */ | |
| scri_use_default_common_enable_flags | f(1) |
| scri_use_default_partition_enable_flags | f(1) |
| scri_use_default_intra_tool_enable_flags | f(1) |
| scri_use_default_inter_tool_enable_flags | f(1) |
| scri_use_default_tx_quant_enable_flags | f(1) |
| /* Tools used by both inter and intra frames */ | |
| if (scri_use_default_common_enable_flags) { | |
| ... | |
| } | |
| /* Tools related to partitioning */ | |
| if ( !scri_use_default_partition_enable_flags ) { | |
| ... | |
| } | |
| ... | |
| } | |

In each case, the scri_lcr_id identifier may identify a layer configuration record that would set or specify during the decoding process of an associated sequence bitstream any information that relates to video layering. This information may be independent from the information within the sequence configuration record and commonly does not impact its parsing and the interpretation of the parameters contained within it. Similarly, a picture configuration record syntax may contain an associated sequence configuration record id. Again, such sequence configuration record and its information will not impact the parsing of the information in this picture configuration record. However, during decoding a frame/picture that is associated with a corresponding picture configuration record id, a decoder will determine its decoding process by looking at the parameters within the corresponding picture configuration record, and the parameters of the associated sequence and layer configuration records as determined by the IDs defined in such configuration records.

An independent configuration record of a particular type, e.g. a layer, sequence, or picture configuration record, may contain flags that control use of default parameters. In the examples shown in Table 1 and in Table 2 these are parameters scri_use_default_common_-enable_flags, scri_use_default_partition_enable_flags, scri_use_default_intra_tool_enable_flags, scri_use_default_inter_tool_enable_flags, and scri_use_default_tx_quant_enable_flags. These parameters may have been predefined and are known both to the encoder and decoder, or may have been specified elsewhere in the coding syntax. If not set, then additional information regarding alternative tools is provided in the independent configuration record of the current type.

Table 3 illustrates an exemplary syntax for a dependent configuration record. In this embodiment, the configuration record identifier of where the final reconstructed configuration record will be stored, which is the same as SCRbuffer, is shown as a five-bit field, scrd_id. The dependent configuration record also contains a reference to another configuration record (scrd_reference_id) from which it depends. Assuming the syntax shown in Table 1 for the independent sequence configuration records, scr_reference_id may point to the ids stored in indSCRbuffer, while if the syntax in Table 2 is used scrd_reference_id may again point to SCRbuffer. However, in the second example scrd_reference_id is only allowed to point to IDs in SCRbuffer occupied only by independent configuration records. The final reconstructed configuration record for a dependent configuration record is constructed by combining the information from the independent configuration record the dependent configuration record points to and of any new or alternative information contained in this dependent configuration record.

TABLE 3
Exemplary Syntax of a Sequence Type Dependent Configuration Record

| | Type |
|---|---|
| seq_config_record_ dep_opbs( ) { | |
| /* General */ | |
| scrd_ reference_id | f(5) |
| scrd_id | f(5) |
| /* Update flags */ | |
| scrd_update_general_information_flag | f(1) |
| scrd_update_params_flag | f(1) |
| ... | |
| if ( scrd_update_general_information_flag ) { | |
| scrd_lcr_id | f(5) |
| scrd_profile | f(3) |
| ... | |
| } | |
| if ( scrd_update_interpretation_flag ) | |
| content_interpretation_info( ) | |
| if ( scrd_update_params_flag ) { | |
| scrd_use_default_common_enable_flags | f(1) |
| scrd_use_default_partition_enable_flags | f(1) |
| scrd_use_default_intra_tool_enable_flags | f(1) |
| scrd_use_default_inter_tool_enable_flags | f(1) |
| scrd_use_default_tx_quant_enable_flags | f(1) |
| } | |
| if ( scrd_update_params_flag && !scrd_use_default_common_enable_flags ) { | |
| scrd_enable_xxx_flag | f(1) |
| ... | |
| } | |
| if ( scrd_update_params_flag && ! scrd_use_default_partition_enable_flag ) { | |
| scrd_enable_partition_tool_flag | f(1) |
| ... | |
| } | |
| if ( scrd_update_params_flag && !scrd_use_default_intra_tool_enable_flags ) { | f(1) |
| scrd_enable_tool_flag | f(1) |
| ... | |
| } | |
| ... | |
| } | |

Here, again, the dependent configuration record may be associated with an id to a layer configuration record using the syntax element scrd_lcr_id and has the same functionality as for the same information in an independent configuration record (i.e. associating any video data that uses this sequence type configuration record with also the corresponding parameters and information defined in a layer type configuration record with that id). In a preferred embodiment the associated layer configuration record id is always indicated in even dependent sequence level configuration records, or, in an alternative embodiment, can be optional and controlled by parameters indicated within the dependent sequence configuration record.

Tables 1, 2, and 3 illustrate configuration records for use with sequence parameters. The independent record may contain indications for certain default parameter at the sequence level as indicated by the syntax element (scri_use_default_common_enable_flags). Additionally, it may also contain information indicating the values/settings of various categories of tools. For example, setting scri_use_default_partition_enable_flags to 1 may indicate that the default parameters are used for the partitioning tools. When scri_use_default_partition_enable_flags is set to 0, it may indicate that partitioning information is signaled in the configuration record.

In the dependent configuration record, additional updates can be signaled. For example, setting scrd_use_default_partition_enable_flags to 1 can update the partitioning information referenced by scrd_independent_reference_id. Similarly, other syntax elements from the reference independent configuration record can be updated. The updates within a dependent configuration record can be made in multiple ways. For example, signaling may indicate that a certain parameter should be overwritten by information provided in the dependent configuration records. Alternatively, signaling may indicate that a parameter from the independent configuration record is used as a predictor and one or more parameters, e.g. an offset or both a weight and an offset are signaled to generate a final value.

In another embodiment, and based on the syntax provided in Table 2, a part of the id spectrum among the independent and dependent configuration records may be “reserved” by the coding specification or alternatively by an encoder during a coding session. In one implementation, when a configuration record identifier is assigned to an independent configuration record, it may not be later reused for a dependent configuration record at a later time during the coding session. In another implementation, a coding session may be defined in which a predetermined number (say N) out of the maximum (M) number of configuration records are reserved to be independent configuration records.

TABLE 4
Exemplary Syntax of a Dependent Configuration Record

| | Type |
|---|---|
| seq_config_record_ dep_opbs( ) { | |
| /* General */ | |
| scrd_reference_id | f(5) |
| scrd_id | f(5) |
| /* Update flags */ | |
| scrd_update_general_information_flag | f(1) |
| scrd_update_params_flag | f(1) |
| . . . | |
| if ( scrd_update_general_information_flag ) { | |
| scrd_lcr_id | f(5) |
| scrd_profile | f(3) |
| ... | |
| } | |
| ... | |
| } | |

In the case of multi-hypothesis configuration records, a syntax element (scrd_hypothesis_prediction_idc) can be provided in a configuration record to indicate prediction, for example, as shown in Table 5. When scrd_hypothesis_prediction_idc is equal to 0, it may indicate that the parameters are coded independently (i.e. to overwrite) from the parameters from the reference configuration record. When scrd_hypothesis_prediction_idc is equal to 1, it may indicate that parameters are coded with reference to a single independent configuration record. The signaling of reference id can be avoided if the “predicting” configuration id is predetermined prior to the decoding, for example, by priority rules that govern the video coding session.

TABLE 5
Exemplary Syntax of a Multi-Hypothesis
Dependent Configuration Record

| | Type |
|---|---|
| seq_config_record_ dep_opbs( ) { | |
| /* General */ | |
| scr_id | f(5) |
| scrd_hypothesis_prediction_idc | f(2) |
| scrd_reference_id0 | f(5) |
| scrd_reference_id1 | f(5) |
| /* Update flags */ | |
| scrd_update_general_information_flag | f(1) |
| scrd_update_params_flag | f(1) |
| ... | |
| if ( scrd_update_general_information_flag ) { | |
| scrd_lcr_id | f(5) |
| scrd_profile | f(3) |
| ... | |
| } | |
| if ( scrd_update_interpretation_flag ) | |
| content_interpretation_info( ) | |
| if ( scrd_update_params_flag ) { | |
| scrd_use_default_common_enable_flags | f(1) |
| scrd_use_default_partition_enable_flags | f(1) |
| scrd_use_default_intra_tool_enable_flags | f(1) |
| scrd_use_default_inter_tool_enable_flags | f(1) |
| scrd_use_default_tx_quant_enable_flags | f(1) |
| } | |
| ... | |
| } | |

When scrd_hypothesis_prediction_mode_idc is equal to 2, such as shown in Table 6, it may indicate that two predictors are used or that the number of additional reference configuration sets IDs can be indicated. For example, in the case of biprediction, the prediction may be restricted to two independent configuration records. In such an instance, the indices of both configuration records used may first be indicated. This can be done once for an entire configuration record, or per group of parameters that are to be predicted using biprediction. Afterwards, prediction can be performed by averaging the values from both reference configuration records. Residual information could also be signaled, e.g. for filter coefficients. In cases where no residual is present, as in the case of picture partitioning or error resiliency features, then configuration record may not contain any updates and could refer to the information parsed in the first or primary independent reference configuration record.

TABLE 6
Exemplary Syntax of a Multi-Hypothesis Dependent
Configuration Record, with scrd_hypothesis_{—}
prediction_idc Equal to 2

| | Type |
|---|---|
| seq_config_record_ dep_opbs( ) { | |
| /* General */ | |
| scr_id | f(5) |
| scrd_hypothesis_prediction_idc | f(2) |
| scrd_reference_id0 | f(5) |
| if (scrd_hypothesis_prediction_idc = = 2) { | |
| scrd_num_hypothesis_minus_1 | uvlc( ) |
| NumHypothesis = scrd_num_hypothesis_minus_1 + 1 | |
| for (i = 0; i < NumHypothesis; i++) | |
| scrd_independent_reference_id[i] | f(5) |
| } | |
| /* Update flags */ | |
| scrd_update_general_information_flag | f(1) |
| scrd_update_params_flag | f(1) |
| ... | |
| if ( scrd_update_general_information_flag ) { | |
| scrd_lcr_id | f(5) |
| scrd_profile | f(3) |
| ... | |
| } | |
| if ( scrd_update_interpretation_flag ) | |
| content_interpretation_info( ) | |
| if ( scrd_update_params_flag ) { | |
| scrd_use_default_common_enable_flags | f(1) |
| scrd_use_default_partition_enable_flags | f(1) |
| scrd_use_default_intra_tool_enable_flags | f(1) |
| scrd_use_default_inter_tool_enable_flags | f(1) |
| scrd_use_default_tx_quant_enable_flags | f(1) |
| } | |
| ... | |
| } | |

The principles of the present disclosure also apply to coding systems in which parameter information of a given type is conveyed in hierarchical layers. The present disclosure supports prediction among configuration records of a given type in a plurality of “layers” at any level in the coding hierarchy. For example, layers may be labeled the Ok-layer, 1^{st}-layer, 2^{nd}-layer and so on. In such an application, a first configuration record of type X of the Ok-layer may be an independent layer (alternatively called a primary layer) that has its parameters coded initially without any dependency on any other layers within the same parameter set level/type. Configuration records of type X in the 1^{st}-layer may predict from the configuration records or type X in the 0^{th} layer. Configuration records of type X in the 2^{nd}-layer may predict from the configuration records of type X in the 1^{st} and/or the 0^{th} layer and so on. Alternatively, it may also be possible to constrain the prediction by limiting the number of layers that can be used during prediction. To elaborate further, a 0¹-layer can be a primary or independent layer, where all the parameters within that layer are independently coded. For subsequent layers multi-hypothesis prediction of a certain degree can be allowed from lower layers depending on the index of the current layer coded, e.g. the 1^{st}-layer can be a dependent layer (only from 0^{th} layer references).

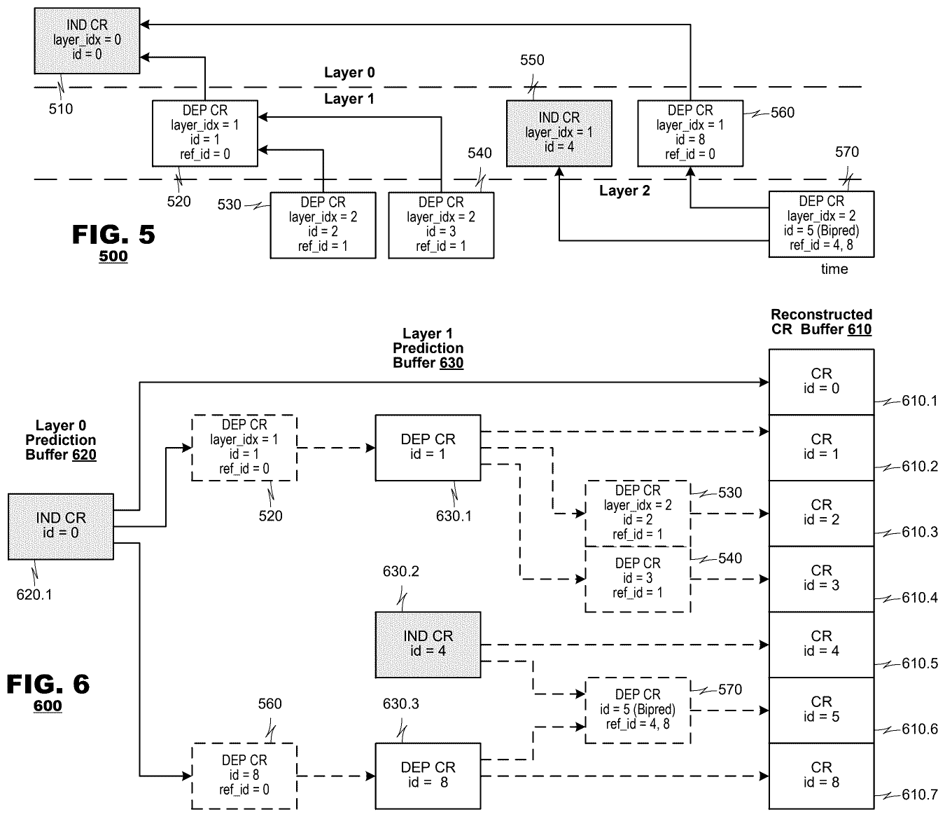

FIG. 5 illustrates an exemplary application of predictively coded configuration records to a multi-layer hierarchy 500. In this example, a first configuration record 510 is shown as a member of a 0^{th} Layer, configuration records 520, 550, and 560 are shown as members of a 1^{st} Layer, and configuration records 530, 540, and 570 are shown as members of a 2^{nd} Layer. The configuration records 510-590 have identifiers (id) that uniquely identify the configuration record. The configuration records 510-590 also have layer indices (layer_idx) that identify the layer to which they belong.

The configuration record 510 of the 0^{th} Layer is an independent coding record that does not rely on any other configuration record as a source of prediction. Similarly, the configuration record 550 of the 1^{st} Layer is an independent coding record that does not rely on any other configuration record as a source of prediction. The dependent configuration records 520, 530, 540, 560, and 570 have identifiers (ref_id) that identify other configuration record(s) on which they rely. In this example, configuration records 520, 530, 540, and 560 each are shown as depending from a single configuration record, and configuration record 570 is shown as depending from two configuration records 550 and 560.

Hierarchies among coding layers, such as the hierarchy shown in FIG. 5, may be instantiated independently for different layers of video data. In this manner, there may be multiple hierarchies among layers of configuration records in a coding session, each of which applies to a respective layer of video data.

FIG. 6 illustrates an exemplary buffer management technique according to an embodiment of the present disclosure. The example of FIG. 6 illustrates buffer management in the context of the configuration records illustrated in FIG. 5. In this embodiment, an encoder and a decoder (FIG. 1) may maintain a reconstruction buffer 610 for reconstructed configuration records. Thus, FIG. 6 illustrates a reconstruction buffer 610 for storage of a reconstructed configuration record 610.1 corresponding to configuration record 510 for layer 0 in FIG. 5, for storage of configuration records 610.2, 610.5, and 610.7 corresponding to configuration records 520, 550, and 560 from layer 1 in FIG. 5, and for storage of configuration records 610.3, 610.4, and 610.6 from layer 2. The reconstructed configuration records 610.1-610.7 may store parameter data that is referenced during encoding and decoding operations.

An encoder and decoder (FIG. 1) also may maintain prediction buffers corresponding to the layers for which configuration records are received that serve as prediction references for other configuration records. In the example of FIG. 5, configuration records 510, 520, 550, and 560 from layers 0 and 1 serve as prediction references for other configuration records 520, 530, 540, 560, and 570. Thus, FIG. 6 illustrates prediction buffers 620 and 630 corresponding to layers 0 and 1. The layer 0 prediction buffer 620 may store a recovered configuration 620.1 corresponding to configuration record 510. The layer 1 prediction buffer 630 may store recovered configuration records 630.1, 630.2, and 630.3 corresponding to configuration records 520, 550, and 560 in FIG. 5.

FIG. 6 illustrates with phantom lines how content of the stored configuration records 630.1 and 630.3 are derived respectively from the dependent configuration records 520, 560 and the recovered configuration record 620.1 corresponding to configuration record 510. FIG. 6 further illustrates with phantom lines how content of the recovered configuration records 610.1-610.7 are derived from the configuration records 620.1, 630.1-630.3 that are stored in the prediction buffers 620, 630 and, as appropriate, the communicated dependent configuration records 530, 540, 570.

The configuration records 510-570 shown in the examples of FIGS. 5 and 6 relate to configuration records of a single type (e.g. a layer, sequence, or picture configuration record). In many coding systems, configuration records will be used to communicate parameter between encoders and decoders (FIG. 1) for several different types, each of which communicates parameter information at different such granularities within the coding syntax. Thus, the principles of FIGS. 5 and 6 may be repeated at each of these types of granularities.

Table 7 illustrates exemplary syntax of an independent configuration record at the 0th layer in a multi-layer embodiment:

TABLE 7
Exemplary Syntax of an Independent Configuration
Record at the 0th Layer

| | Type |
|---|---|
| seq_config_record_ indep_opbs( ) { | |
| /* General */ | |
| scri_id | f(5) |
| layer_idx | f(3) |
| ... | |
| scri_initial_params_present_flag | f(1) |
| if ( scri_initial_params_present_flag) { | |
| scri_tool_params1 | uvlc( ) |
| scri_tool_params2 | uvlc( ) |
| ... | |
| } | |
| ... | |
| } | |

Table 8 show exemplary syntax of a configuration record at a first predictive layer in a multi-layer embodiment:

TABLE 8
Exemplary Syntax of a Configuration
Record at a 1st Predictive Layer

| | Type |
|---|---|
| seq_config_record_ dep_opbs( ) { | |
| /* General */ | |
| scrd_id | f(5) |
| layer_idx | f(3) |
| scrd_ref_id | f(5) |
| scrd_prediction _params_present_flag | f(1) |
| if ( scrd_prediction_params_present_flag) { | |
| scrd_tool_params1_predicted_value | uvlc( ) |
| scrd_tool_params2_predicted_value | uvlc( ) |
| ... | |
| } | |
| ... | |
| } | |

In this embodiment, the scrd_id of the configuration record in the first predictive layer may reference another configuration record from the first predictive layer or a configuration record from the 0^{th} layer. For dependent records, layer_idx can take values of 1 or higher.

Table 9 shows exemplary syntax of a configuration record at a second predictive layer in a multi-layer embodiment:

TABLE 9
Exemplary Syntax of a Configuration
Record at a Second Predictive Layer

| | Type |
|---|---|
| seq_config_record_ dep_opbs( ) { | |
| /* General */ | |
| scrd_id | f(5) |
| layer_idx | f(3) |
| scrd_ref_id | f(5) |
| ... | |
| scrd_secondary_prediction _params_present_flag | f(1) |
| if ( scrd_secondary_prediction_params_present_flag) { | |
| scrd_tool_secondary_params1_predicted_value | uvlc( ) |
| scrd_tool_secondary_params2_predicted_value | uvlc( ) |
| ... | |
| } | |
| ... | |
| } | |

In this embodiment, the scrd_id of the configuration record in the second predictive layer may reference another configuration record from the second predictive layer or a configuration record from a lower layer.

The principles of the present disclosure may be extended to an arbitrary number of layers of a configuration type. In general, configuration records at each layer depth would indicate its correspondence id in the list of configuration records and its reference configuration record or records from a lower level (higher priority) layer of the same configuration type. In order to determine the information of a particular layer, a decoder first would decode all configuration records to which it refers.

The use of configuration records used in hierarchies may be useful to signal configuration parameters at different levels in a coding syntax, for example, sequence parameters, picture parameters, and the like. Thus, in the example of FIG. 5, the configuration records of layer 0 may represent sequence parameter configuration records, and the configuration records of layer 1 may represent picture parameter configuration records. The principles of the present disclosure may be extended to other sets of parameter data provided at other granularities within a syntax hierarchy. In such applications, the number of coding/decoding buffers and prediction buffers may be extended to match.

Examples of syntax showing the relation between a layer configuration record, a sequence configuration record, and a picture configuration record are shown below:

TABLE 10
Exemplary Syntax of a Layer Configuration Record

| | Type |
|---|---|
| layer_config_opbs ( ) { | |
| lcri_id | f(5) |
| operating_point_information( ) | |
| lcri_base_layer_present_idc | f(2) |
| lcri_maximum_layers_minus_1 | f(8) |
| lcri_layer_dependency_flag | f(1) |
| if ( !lcri_layer_dependency_flag ) { | |
| // syntax describing which layer predicts from which one | |
| } | |
| lcri_timing_info_present_flag | f(1) |
| if ( lcri_timing_info_present_flag ) | |
| decoder_model_timing_info( ) | |
| } | |

TABLE 11
Exemplary Syntax of a Sequence Configuration Record

| | Type |
|---|---|
| seq_config_record { | |
| scri_id | f(5) |
| scri_lcri_id | f(5) |
| scri_max_sublayers_minus_1 | |
| scri_still_picture | f(1) |
| if ( scri_still_picture ) | |
| scri_reduced_still_picture_header | f(1) |
| scri_profile_timinig_information_present_flag | |
| if ( scri_profile_timing_information_present_flag && | |
| !scri_reduced_still_picture_header ) { | |
| profile_tier_level( 1, scri_max_sublayers_minus_1 ) | |
| } | |
| ... | |
| } | |

TABLE 12
Exemplary Syntax of a Picture Configuration Record

| | Type |
|---|---|
| pic_config_record_indep( ) { | |
| pcri_id | f(5) |
| pcri_scri_id | f(5) |
| tile_info( ) | |
| seg_info( ) | |
| quant_info ( ) | |
| cdef_info( ) | |
| loop_filter_info( ) | |
| ccso_info( ) | |
| ... | |
| } | |

Table 10 through Table 12 show exemplary syntax of a Layer Configuration Record (LCR), Sequence Configuration Record (SCR), and a Picture Configuration Record (PCR). Each of these configuration records are uniquely identifiable with an id, i.e., lc_id (LCR id), scri_id (SCR id) and pcri_id (PCR id) respectively. In the case of the SCR and PCR, it contains an additional id to indicate which higher type of configuration record this type of configuration record is associated with (i.e. scri_lcri_id and pcri_scri_id respectively).

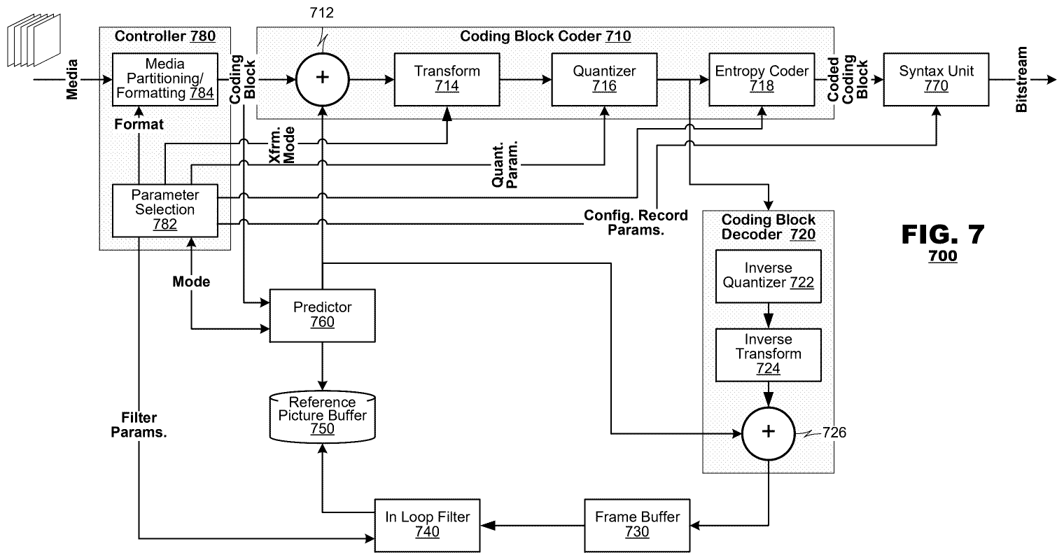

FIG. 7 is a functional block diagram of a coding system 700 according to an aspect of the present disclosure. The system 700 may find application as a media encoder 112, 124 (FIG. 1) for exchange of coded video. The system 700 may include a coding block coder 710, a local coding block decoder 720, a frame buffer 730, an in loop filter system 740, reference picture buffer 750, a predictor 760, and a syntax unit 770, all operating under control of a controller 780.

The coding system 700 may code frames of video according to predictive techniques. According to such techniques, the controller 780 may format and partition input frames into coding blocks (shown as process 784), which the coding block encoder 710 processes on a coding block-by-coding block basis. Formatting operations may involve resizing video frames according to frame width and height parameters selected for a coding sequence, temporally interpolating frames as necessary according to frame rate parameters selected for the coding sequence, and partitioning frames into coding unit sizes selected for the frames. Further, the controller 780 may select operational parameters that are to be applied by other elements of the coding system 700. The controller 700 may supply indications of such coding parameters to the syntax unit 770, which may supply independent and dependent configuration records in an output bitstream according to the principles discussed above.

The coding block coder 710 may present coded coding block data to the syntax unit 770, which formats the coded coding block data into a transmission syntax that conforms to a governing coding protocol. The local pixel block decoder 720 may decode the coded coding block data, generating decoded coding block data therefrom. The frame buffer 730 represent reconstruction of frame content at super-pixel block granularities, upon which filtering operations may be performed. The in-loop filter 740 may perform one or more filtering operations on the reconstructed frame. For example, the in-loop filter 740 may perform deblocking filtering, sample adaptive offset (SAO) filtering, adaptive loop filtering (ALF), maximum likelihood (ML) based filtering schemes, deringing, debanding, sharpening, resolution scaling, and the like. Filtered frames may be stored in a reference picture buffer 750 where they may be used as a source of prediction of later-received frames and coding blocks.

The coding block coder 710 may include a subtractor 712, a transform unit 710, a quantizer 716, and an entropy coder 710. The coding block coder 710 may accept coding blocks of input data at the subtractor 712. The subtractor 712 may receive predicted coding blocks from the predictor 760 and generate an array of pixel residuals therefrom representing a difference between the input coding block and the predicted coding block. The transform unit 710 may apply a transform to the sample data output from the subtractor 712, to convert data from the pixel domain to a domain of transform coefficients. In some scenarios (for example, when operating on high dynamic range content) prior to transform unit 710 and/or subtractor 712, the input may be reshaped, or an adaptation scheme be applied to adjust to the content transfer characteristics. Such an adaptation can be either a simple scaling, based on a re-mapping function, or a more sophisticated pixel manipulation technique. The quantizer 716 may perform quantization of transform coefficients output by the transform unit 710 according to a quantization parameter qp. The quantizer 716 may apply either uniform or non-uniform quantization parameters; non-uniform quantization parameters may vary across predetermined locations of the block of coefficients output from the transform unit 710. The entropy coder 710 may reduce bandwidth of the output of the coefficient quantizer by coding the output, for example, by variable length code words or using a context adaptive binary arithmetic coder.

The transform unit 710 may operate in a variety of transform modes as determined by the controller 780. The controller 780 may select one of the transforms described hereinabove according to the controller's determination of coding efficiencies that will be obtained from the selected transform. Once the transform to be used for coding is selected, the controller 780 may determine whether it is necessary to signal its selection of the transform.

The quantizer 716 may operate according to a quantization parameter qp that is determined by the controller 780. Quantization parameters may be developed with respect to quantization matrices that the controller 780 may provide to the syntax unit 770 to be signaled in a configuration record at a hierarch level that corresponds to a coding block unit.

The entropy coder 710, as its name implies, may perform entropy coding of data output from the quantizer 716. For example, the entropy coder 710 may perform run length coding, Huffman coding, Golomb coding, Context Adaptive Binary or Multisymbol Arithmetic Coding, and the like. Once an entropy coding type to be used for coding is selected, the controller 780 may determine whether it is necessary to signal its selection of the entropy coding type and, if so, may signal its selection to a decoder.

The local pixel block decoder 720 may invert coding operations of the coding block coder 710. For example, the local pixel block decoder 720 may include an inverse quantizer 722, an inverse transform unit 724, and an adder 726. In some scenarios (for example, when operating on high dynamic range content) post to inverse transform unit 724 and/or adder 726, the input may be inverse reshaped or re-mapped typically according to a function that was applied at the encoder and content characteristics. The local pixel block decoder 720 may take its input data from an output of the quantizer 716. Although permissible, the local pixel block decoder 720 need not perform entropy decoding of entropy-coded data since entropy coding is a lossless event. The inverse quantizer 722 may invert operations of the quantizer 716 of the coding block coder 710. Similarly, the inverse transform unit 724 may invert operations of the transform unit 710. The inverse quantizer 722 and the inverse transform unit 724 may use the same quantization parameters qp and transform modes as their counterparts in the coding block coder 710 (paths not shown in FIG. 7). Quantization operations likely will truncate data in various respects and, therefore, data recovered by the inverse quantizer 722 likely will possess coding errors when compared to the data presented to the quantizer 716 in the coding block coder 710.

The adder 726 may invert operations performed by the subtractor 712. It may receive the same prediction coding block from the predictor 760 that the subtractor 712 used in generating residual signals. The adder 726 may add the prediction coding block to reconstructed residual values output by the inverse transform unit 724 and may output reconstructed coding block data.

As described, the frame buffer 730 may assemble frame data from the output of the local pixel block decoder 720 at granularities larger than pixel blocks. The in-loop filter 740 may perform various filtering operations on recovered coding block data. For example, the in-loop filter 740 may include a deblocking filter, a sample adaptive offset (“SAO”) filter, and/or other types of in loop filters (not shown). Filter type and filter parameters may be selected by a controller 780, which may determine whether it is necessary to signal its selection in the output bitstream. If so, the controller 780 may signal its selection in a configuration record at a hierarchy level that corresponds to a frame.

The reference picture buffer 750 may store filtered frame data output by the in-loop filter 740 for use in later prediction of other coding blocks.

Different types of prediction data are made available to the predictor 760 for different prediction modes. For example, for an input coding block, intra prediction takes a prediction reference from decoded data of the same frame in which the input coding block is located. Thus, the reference frame store 750 may store decoded coding block data of each frame as it is coded. For the same input coding block, inter prediction may take a prediction reference from previously coded and decoded frame(s) that are designated as reference frames. Thus, the reference frame store 750 may store these decoded reference frames.

The predictor 760 may supply prediction blocks to the coding block coder 710 for use in generating residuals. The predictor 760 may perform prediction search operations according to intra mode coding, and uni-predictive, bi-predictive, and/or multi-hypothesis inter mode coding. For intra mode coding, the predictor 760 may search from among coding block data from the same frame as the coding block being coded that provides the closest match to the input coding block. For inter mode coding, the predictor 760 may search from among coding block data of other previously coded frames stored in the reference picture buffer 750 that provides a match to the input coding block. From among the predictions generated according to the various modes, the predictor 760 may select a mode that achieves the lowest distortion when video is decoded given a target bitrate. Exceptions may arise when coding modes are selected to satisfy other policies to which the coding system 700 adheres, such as satisfying a particular channel behavior, or supporting random access or data refresh policies, which may be determined by the controller 780.

The controller 780 may control overall operation of the coding system 700. The controller 780 may select operational parameters for the coding block coder 710 and the predictor 760 based on analyses of input coding blocks and also external constraints, such as coding bitrate targets and other operational parameters. The controller 780 may determine how to represent those selections in coded video data that is output from the system 700. The controller 780 also may select between different modes of operation by which the system may generate reference images and may include metadata identifying the modes selected for each portion of coded data.

During operation, the controller 780 may revise operational parameters of the quantizer 716 and the transform unit 715 at different granularities of image data, either on a per coding block basis or on a larger granularity (for example, per frame, per slice, per largest coding unit (“LCU”) or Coding Tree Unit (CTU), or another region). In an aspect, the quantization parameters may be revised on a per-pixel basis within a coded frame.

Additionally, as discussed, the controller 780 may control operation of the in-loop filter 750 and the prediction unit 760. Such control may include, for the prediction unit 760, mode selection (lambda, modes to be tested, search windows, distortion strategies, etc.), and, for the in-loop filter 750, selection of filter parameters, reordering parameters, weighted prediction, etc.

As discussed, the controller 780 may cause the syntax unit 770 to signal its selections of the various parameters applied during coding in independent and dependent configuration records.

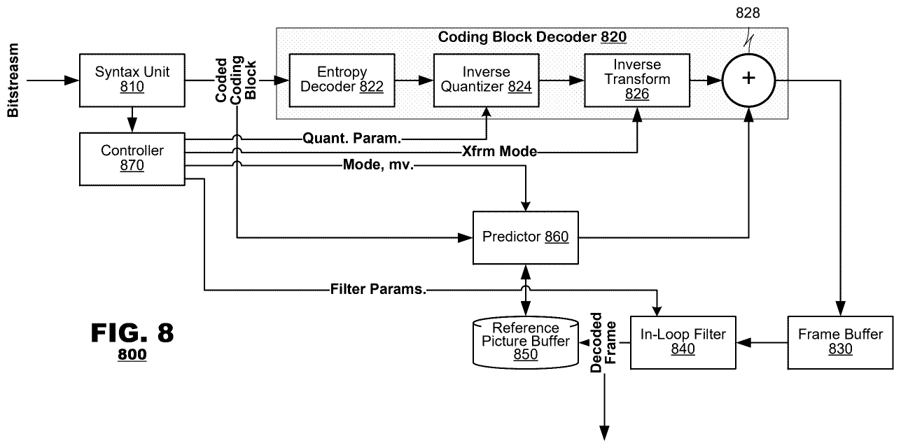

FIG. 8 is a functional block diagram of a decoding system 800 according to an aspect of the present disclosure. The decoding system 800 may find application as a video decoder 122, 114 (FIG. 1) for exchange of coded video. The decoding system 800 may include a syntax unit 810, a coding block decoder 820, a frame buffer 830, an in-loop filter 840, a reference picture buffer 850, a predictor 860, and a controller 870.

The syntax unit 810 may receive a coded video data stream and may parse the coded data into its constituent parts. Data representing configuration records may be furnished to the controller 870, while data representing coded residuals (the data output by the coding block coder 710 of FIG. 7) may be furnished to the coding block decoder 820. The controller 870 may set operational parameters of the coding block decoder 820, in-loop filter 840, and predictor 860 according to information supplied in the configuration records.

During operation, the predictor 860 may generate a prediction block from reference frame data available in the reference picture buffer 850 as determined by coding parameter data provided in the coded bitstream. The predictor 860 may supply the prediction block to the coding block decoder 820.

The coding block decoder 820 may invert coding operations applied by the coding block coder 710 (FIG. 7). The frame buffer 830 may create a reconstructed frame from decoded coding blocks output by the coding block decoder 820. The in-loop filter 840 may filter the reconstructed frame data. The filtered frames may be output from the decoding system 800. Filtered frames that are designated to serve as reference frames also may be stored in the reference picture buffer 850.

The coding block decoder 820 may include an entropy decoder 822, an inverse quantizer 824, an inverse transform unit 826, and an adder 828. The entropy decoder 822 may perform entropy decoding to invert processes performed by the entropy coder 710 (FIG. The inverse quantizer 824 may invert operations of the quantizer 716 of the coding block coder 710 (FIG. 7). Similarly, the inverse transform unit 826 may invert operations of the transform unit 710 (FIG. 7). They may use the quantization parameters and transform modes that are identified by the encoder either expressly or impliedly. Because quantization is likely to truncate data, the coding blocks recovered by the inverse quantizer 824 likely will possess coding errors when compared to the input coding blocks s presented to the coding block coder 710 of the encoder (FIG. 7).

The adder 828 may invert operations performed by the subtractor 710 (FIG. 7). It may receive a prediction coding block from the predictor 860 as determined by prediction references in the coded video data stream. The adder 828 may add the prediction coding block to reconstructed residual values output by the inverse transform unit 826 and may output reconstructed coding block data.

As described, the frame buffer 830 may assemble a reconstructed frame from the output of the coding block decoder 820. The in-loop filter 840 may perform various filtering operations on recovered coding block data as identified by the coded video data. For example, the in-loop filter 840 may include a deblocking filter, a sample adaptive offset (“SAO”) filter, and/or other types of in loop filters. In this manner, operation of the frame buffer 830 and the in loop filter 840 mimic operation of the counterpart frame buffer 730 and in loop filter 740 of the encoder 700 (FIG. 7).

The reference picture buffer 850 may store filtered frame data for use in later prediction of other coding blocks. The reference picture buffer 850 may store decoded frames as it is coded for use in intra prediction. The reference picture buffer 850 also may store decoded reference frames.

As discussed, the predictor 860 may supply the prediction blocks to the coding block decoder 820 according to a coding mode identified in the coded video data. The predictor 860 may supply predicted coding block data as determined by the prediction reference indicators supplied in the coded video data stream.

The controller 870 may control overall operation of the coding system 800. The controller 870 may set operational parameters for the coding block decoder 820 and the predictor 860 based on parameter information developed from configuration records.

The principles of the present disclosure find application not only in video/imaging applications but also to other types of media that use similar high level syntax information. For example, the principles of the present disclosure apply to signaling of parameter sets in audio, point clouds, meshes, or other types of data, to describe coding properties of such information at different temporal or spatial levels.

The foregoing discussion has described operation of the aspects of the present disclosure in the context of video coders and decoders. Commonly, these components are provided as electronic devices. Video decoders and/or controllers can be embodied in integrated circuits, such as application specific integrated circuits, field programmable gate arrays, and/or digital signal processors. Alternatively, they can be embodied in computer programs that execute on camera devices, personal computers, notebook computers, tablet computers, smartphones, or computer servers. Such computer programs typically are stored in physical storage media such as electronic-, magnetic-, and/or optically-based storage devices, where they are read to a processor and executed. Decoders commonly are packaged in consumer electronics devices, such as smartphones, tablet computers, gaming systems, DVD players, portable media players and the like; and they also can be packaged in consumer software applications such as video games, media players, media editors, and the like. And, of course, these components may be provided as hybrid systems that distribute functionality across dedicated hardware components and programmed general-purpose processors, as desired.

We claim:

1. An encoding method, comprising:
developing sets of parameter information used during coding of input media,
developing configuration records corresponding to the sets of parameter information, each configuration record having an identifier that distinguishes the configuration record from other configuration records,
communicating the configuration records to a channel, wherein at least one communication record is represented as a dependent configuration record type, which indicates that parameter information for the dependent configuration record is to be derived from another previously-developed configuration record and contains an identifier of the other configuration record on which it depends, and
coding the input media predictively using parameter information of the dependent configuration record.

2. The encoding method of claim 1, further comprising repeating the method for sets of parameter information at different granularities in a coding hierarchy, wherein, for each granularity, configuration records are developed representing the parameters at the respective granularity of independent and dependent configuration record types.

3. The encoding method of claim 1, wherein the dependent configuration record identifies parameter information applicable to coding a sequence of frames of video.

4. The encoding method of claim 1, wherein the dependent configuration record identifies parameter information applicable to coding a single frame of video.

5. The encoding method of claim 1, wherein the dependent configuration record identifies parameter information applicable to coding audio data.

6. The encoding method of claim 1, wherein the dependent configuration record identifies parameter information applicable to coding point cloud-based media.

7. The encoding method of claim 1, wherein the dependent configuration record identifies parameter information applicable to coding mesh-based media.

8. The encoding method of claim 1, wherein the dependent configuration record and the configuration record on which it depends are members of a common hierarchical layer of a multi-layer architecture.

9. The encoding method of claim 1, wherein the dependent configuration record and the configuration record on which it depends are members of different hierarchical layers of a multi-layer architecture.

10. The encoding method of claim 1, wherein the dependent configuration record identifies a mode of predicting parameter information from the other configuration record on which it depends.

11. The encoding method of claim 10, wherein, when the mode indicates multi-hypothesis prediction, the dependent configuration record includes weighting information for multiple prediction hypotheses.

12. A decoding method, comprising:
receiving, from a bitstream representing coded media, configuration records corresponding to sets of parameter information used to code media, each configuration record having an identifier that distinguishes the configuration record from other configuration records;
when a received configuration record is identified as a dependent configuration record:
predicting parameter information for the configuration record from parameter information of a previously-received configuration record, the previously-received configuration record identified by an identifier supplied in the dependent configuration record, and
supplementing the predicted information with parameter information supplied in the received dependent configuration record; and
decoding receive coded media using parameter information of the dependent configuration record.

13. The decoding method of claim 12, wherein the bitstream contains configuration records for sets of parameter information at different granularities in a coding hierarchy, and the predicting and supplementing is performed independently for dependent configuration records at the different granularities.

14. The decoding method of claim 12, wherein the dependent configuration record identifies parameter information applicable to coding a sequence of frames of video.

15. The decoding method of claim 12, wherein the dependent configuration record identifies parameter information applicable to coding a single frame of video.

16. The decoding method of claim 12, wherein the dependent configuration record identifies parameter information applicable to coding audio data.

17. The decoding method of claim 12, wherein the dependent configuration record identifies parameter information applicable to coding point cloud-based media.

18. The decoding method of claim 12, wherein the dependent configuration record identifies parameter information applicable to coding mesh-based media.

19. The decoding method of claim 12, wherein the dependent configuration record and the configuration record on which it depends are members of a common hierarchical layer of a multi-layer architecture.

20. The decoding method of claim 12, wherein the dependent configuration record and the configuration record on which it depends are members of different hierarchical layers of a multi-layer architecture.

21. The decoding method of claim 12, wherein the dependent configuration record identifies a mode of predicting parameter information from the other configuration record on which it depends.

22. The decoding method of claim 21, wherein, when the mode indicates multi-hypothesis prediction, the dependent configuration record includes weighting information for multiple prediction hypotheses.

23. A computer readable medium storing instruction that, when executed by a processor, cause the processor to:
develop sets of parameter information used during coding of input media,
develop configuration records corresponding to the sets of parameter information, each configuration record having an identifier that distinguishes the configuration record from other configuration records,
communicate the configuration records to a channel, wherein at least one communication record is represented as a dependent configuration record type, which indicates that parameter information for the dependent configuration record is to be derived from another previously-developed configuration record and contains an identifier of the other configuration record on which it depends, and
code the input media predictively using parameter information of the dependent configuration record.

24. A computer readable medium storing instruction that, when executed by a processor, cause the processor to:
responsive to reception, from a bitstream representing coded media, of configuration records corresponding to sets of parameter information used to code media, each configuration record having an identifier that distinguishes the configuration record from other configuration records, store the received configuration records;
responsive to reception of a configuration record identified as a dependent configuration record:
predict parameter information for the configuration record from parameter information of a previously-received configuration record, the previously-received configuration record identified by an identifier supplied in the dependent configuration record, and
supplement the predicted information with parameter information supplied in the received dependent configuration record; and
decode receive coded media using parameter information of the dependent configuration record.
